(19) United States
(12) Patent Application Publication
(10) Pub. No.: US 2012/0105031 A1
(43) Pub. Date: May 3, 2012

(54) SWITCHING POWER-SUPPLY UNIT

(75) Inventor: Keizo KUMAGAI, Tokyo (JP)

(73) Assignee: MITSUMI ELECTRIC CO., LTD., Tama-shi (JP)

(21) Appl. No.: 13/283,746

(22) Filed: Oct. 28, 2011

(30) Foreign Application Priority Data
Oct. 29, 2010 (JP) 2010-243746

(51) Int. Cl. G05F 1/10

(52) U.S. Cl. 323/271

(57) ABSTRACT

A switching power-supply unit which controls current flowing through an inductor in a switchable manner and outputs a voltage different from input voltage, the unit including: a terminal-potential detecting circuit which monitors terminal potential of the inductor and outputs a predetermined signal; a comparator which compares an output feedback voltage with a threshold voltage; and a logic circuit which generates a signal for controlling a switching element based on an output from the comparator and an output from the terminal-potential detecting circuit, wherein the comparator compares a first threshold voltage with the feedback voltage in a period in which the output voltage rises, and compares a second threshold voltage which is lower than the first threshold voltage with the feedback voltage in a period in which the output voltage drops.

### BACKGROUND OF THE INVENTION

1. Field of the Invention

The present invention relates to a switching regulator direct-current (DC) power-supply unit for converting a DC voltage, and in particular relates to a switching power -supply unit including a comparator for restricting upper and lower limits of an output voltage with two threshold voltages.

2. Description of Related Art

A switching regulator DC-DC converter is known as a circuit converting DC input voltage into DC voltage different from the input voltage. The DC-DC converter includes a drive switching element which applies DC voltage supplied from a DC power supply such as a battery to an inductor (a coil) to allow current to flow through the coil and stores energy in the coil, a rectifier which rectifies the current in the coil during an energy emission period in which the drive switching element is off, and a control circuit which causes the drive switching element to be turned on or off.

The conventional switching regulator DC-DC converter detects the magnitude of output voltage with an error amplifier and feeds back the detected magnitude to a pulse-width modulation (PWM) control comparator or pulse-frequency modulation (PFM) control comparator. The PWM or PFM comparator controls the width or frequency of pulses so as to lengthen the ON time of the drive switching element in response to a decrease in the output voltage and to shorten the ON time in response to an increase in the output voltage.

The PWM control comparator includes a waveform generator circuit which generates triangular waves at a predetermined frequency and a PWM comparator which compares a voltage in proportion to the output voltage with the triangular waves, and changes the pulse width depending on the output voltage, with the cycle (frequency) of drive pulses fixed. That is, in the PWM control, the pulse width is narrowed at a lower load while the pulse width is widened at a higher load. On the other hand, in the PFM control, the frequency of the pulses is decreased at a lower load while the frequency is increased at a higher load, with the pulse width fixed.

Meanwhile, both in the PWM control and PFM control, the output voltage repeats variations (ripples) such that the output voltage rises while the drive switching element is on and drops while the drive switching element is off. The switching regulator has been required to suppress the ripples of the output voltage because the ripples would adversely affect the load. The PWM control can reduce the ripples by setting a higher switching frequency. Nevertheless, if the load is considerably low, the output voltage often rises even though the regulator is driven with pulses having a minimum pulse width.

On the other hand, The PFM control is advantageous in that the current can be reduced under a low load since the frequency of the pulses decreases under such a low load. However, the PFM control disadvantageously accompanies larger ripples. To suppress the variations (ripples) in the output voltage, a capacitor is employed, and the capacitor needs to have high capacitance for large ripple. It is thus preferable that the regulator itself reduce the ripples of the output voltage. Consequently, an invention of a switching regulator with a hysteresis comparator is proposed to reduce the ripples of the output voltage, as disclosed in, for example, Japanese Patent Application Laid-Open No. 2007-20352.

FIGS. 5 to 7 illustrate the switching regulator disclosed in Japanese Patent Application Laid-Open No. 2007-20352. As illustrated in FIG. 5, this regulator includes a circuit that generates threshold voltages (reference voltages) Vth1 and Vth2 for the hysteresis comparator. Furthermore, this threshold-voltage generating circuit can switch the threshold voltage Vth2 between Vth2H and Vth2L, as shown in FIG. 6.

In the regulator configured as stated above, when voltage Vout′ generated by bleeder resistors R1 and R2 reaches the threshold voltage Vth1 under a low load, output transistors M1 and M2 are turned off after the passage of certain delay time. While the output transistors M1 and M2 are off, the voltage Vout′ drops to t threshold voltage Vth2H. After the passage of predetermined time, the regulator performs again a charge/discharge operation, thereby raising the voltage Vout′. The control of switching the threshold voltage Vth2 between Vth2H and Vth2L can reduce the ripples of the output voltage Vout.

However, the regulator disclosed in Japanese Patent Application Laid-Open No. 2007-20352 has the following problems. The regulator controls the upper and lower limits of the ripples of the voltage Vout′ using two comparators CMP1 and CMP2. As a result, the threshold voltage Vth1 is sometimes lower than Vth2 although the threshold voltages Vth1 and Vth2 are originally supposed to satisfy Vth1<Vth2, due to production tolerance among components constituting the comparators. This possibly precludes normal switching control.

### SUMMARY OF THE INVENTION

The present invention has been achieved in view of such problems. It is an object of the present invention to provide a switching power-supply unit that includes a comparator restricting the upper and lower limits of an output voltage with two threshold voltages and that can perform normal switching control even when there is production tolerance among components constituting the comparator.

According to an aspect of the present invention, there is provided a switching power-supply unit for outputting an output voltage different from an input voltage, including: an inductor connected between a voltage input terminal and an output terminal, wherein a direct-current voltage is input to the voltage input terminal, and a load is connected to the output terminal; a drive switching element which causes current to intermittently flow through the inductor; and a control circuit which generates and outputs a control signal which causes the drive switching element to be turned on or off in accordance with an output feedback voltage, wherein the control circuit includes: a terminal-potential detecting circuit which monitors potential at an upstream terminal of the inductor, and outputs a predetermined signal in accordance with a change in the potential at the upstream terminal; a comparator which compares the feedback voltage proportional to the output voltage with a predetermined threshold voltage; and a logic circuit which generates and outputs the control signal which controls the drive switching element based on a signal output from the comparator and the signal output from the terminal-potential detecting circuit, and wherein the comparator compares a first threshold voltage with the feedback voltage in a period in which the output voltage rises; compares a second threshold voltage with the feedback voltage in a period in which the output voltage drops, the second threshold voltage being lower than the first threshold voltage; and outputs a signal based on a result of the comparison.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a circuit diagram illustrating a configuration of a switching regulator according to an embodiment of the present invention;

FIG. 2 is a circuit diagram illustrating a specific example of a threshold-voltage generating circuit that constitutes the switching regulator of the embodiment;

FIG. 3 is a timing chart illustrating changes in an output feedback voltage, a threshold voltage supplied to a comparator, a voltage at a terminal of a coil, and various signals of the switching regulator according to the embodiment;

FIG. 4 is a circuit diagram of a threshold-voltage generating circuit of another example;

FIG. 5 is a circuit diagram illustrating an exemplary configuration of a conventional switching regulator including a hysteresis comparator;

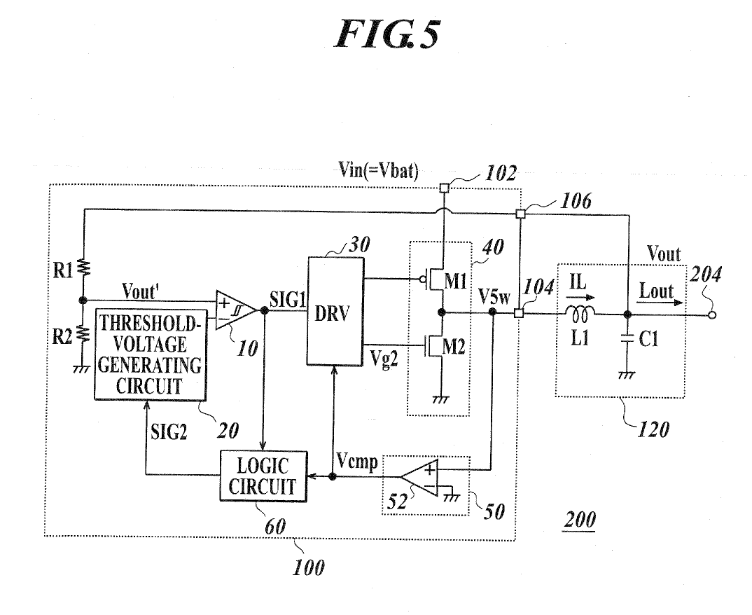

FIG. 6 is a circuit diagram illustrating a specific example of a threshold-voltage generating circuit and the hysteresis comparator in the switching regulator illustrated in FIG. 5; and

FIG. 7 is a timing chart illustrating an operation of the switching regulator illustrated in FIG. 5 under a low load.

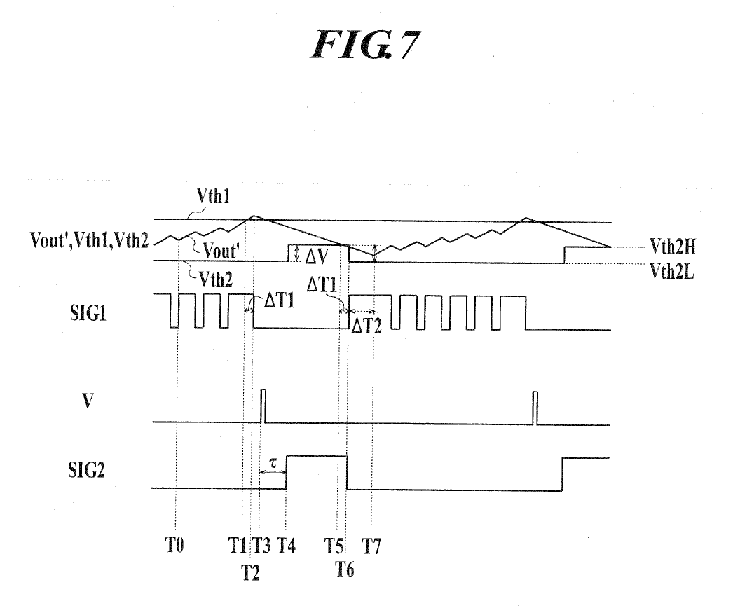

### DESCRIPTION OF THE PREFERRED EMBODIMENTS

Preferred embodiments of the present invention will now be described with reference to the accompanying drawings.

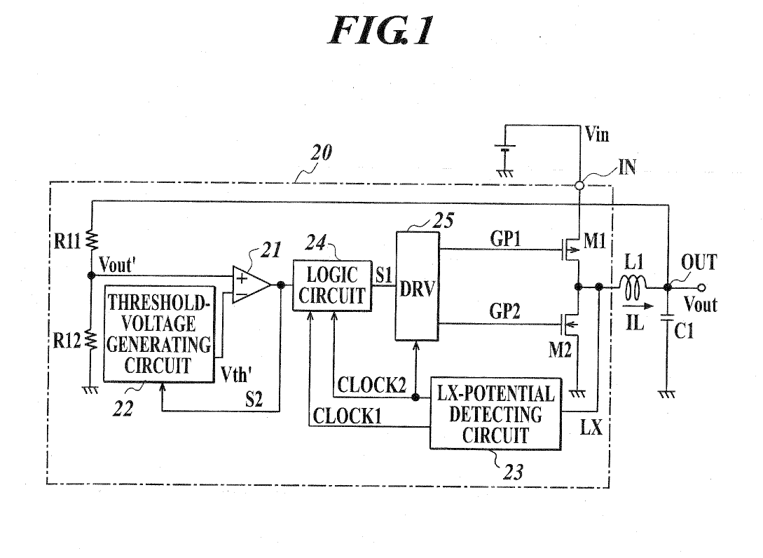

FIG. 1 illustrates a switching regulator DC-DC converter according to an embodiment of the present invention.

The DC-DC converter according to the embodiment illustrated in FIG. 1 includes a coil L1 serving as an inductor; a drive switching element M1 that is a P-channel MOSFET (insulated, gate field effect transistor) connected between a voltage input terminal IN to which DC input voltage Vin applied and one of terminals of the coil L1, which P-channel MOSFET allows drive current to flow through the coil L1; and a rectification switching element M2 that is an N-channel MOSFET connected between the terminal of the coil L1 and a ground point.

The DC--DC converter according to the embodiment also includes a switching control circuit 20 causing the switching elements M1 and M2 to be turned on or off, and a smoothing capacitor C1 connected between the other terminal (an output terminal OUT) of the coil L1 and the ground point.

In the embodiment, among the constituent elements of the DC-DC converter, the switching control circuit 20 may be formed on a semiconductor chip as a semiconductor integrated circuit (power control IC) and the coil L1 and the capacitor C1, as external elements, may be connected to an external terminal of this power control IC. However, the present invention is not limited to such a configuration.

In the DC-DC converter according to the embodiment, the switching control circuit 20 generates drive pulses GP1 and GP2 for complementarily turning on and off the transistors M1 and M2. When the drive transistor M1 is turned on in a stationary state, the DC input voltage Vin is applied to the coil L1, which allows current to flow toward the output terminal OUT, and the smoothing capacitor C1 is charged.

When the drive transistor M1 is turned off, the rectification transistor M2 is turned on and current flows through the coil L1 via the rectification transistor M2 that is in an ON state. DC output voltage Vout stepped down from the DC input voltage Vin is generated in such a way that, at a constant switching cycle, frequencies and pulse widths of the drive pulses GP1 and GP2, which are input to control terminals (gate terminals) of the transistors M1 and M2, are controlled in accordance with output voltage.

The switching control circuit 20 includes bleeder resistors R11 and R12 connected in series between the output terminal OUT and the ground point and dividing the output voltage Vout based on the ratio of resistances; a comparator 21 comparing voltage (output feedback voltage) Vout′, into which the output voltage Vout is divided by the resistors R11 and P12, with threshold voltage Vth, and outputting voltage in response to the result, of comparison; and a threshold-voltage generating circuit 22 generating the threshold voltage Vth to be used for the comparison by the comparator 21.

Furthermore, the switching control circuit 20 includes an LX-potential detecting circuit 23 detecting potential LX at the terminal (hereinafter referred to as “coil upstream terminal”) opposite to the output terminal GUT of the coil L1, a logic circuit 24 generating a control signal S1 which causes the switching elements M1 and M2 to be turned on or off based on an output from the detecting circuit 23 and an output from the comparator 21, and a driver circuit 25 generating and outputting the gate drive signals GP1 and GP2 which turn on or off the switching elements M1 and M2 based on the signal S1 output from the logic circuit 24 so that ON-periods of the switching elements M1 and M2 do not overlap each other. In the claims, either the logic circuit 24 or a combination of the logic circuit 24 and a logical function included in the driver circuit 25 is referred to as “a logic circuit”.

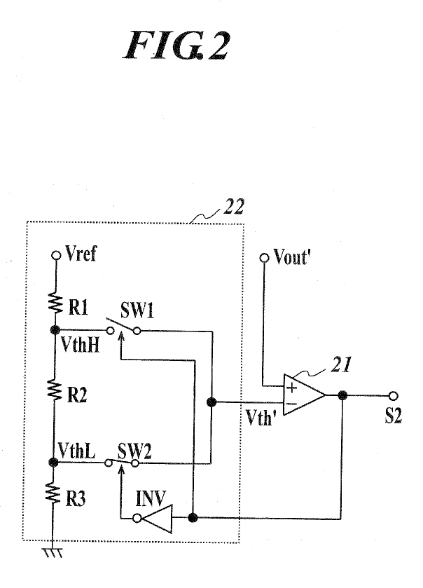

FIG. 2 illustrates a specific example of the threshold-voltage generating circuit 22.

The threshold-voltage generating circuit 22 according to the embodiment includes resistors R1, R2, and R3 which are connected between a reference potential point to which reference voltage Vref is applied and the ground point, divide the reference voltage Vref based on the ratio of resistances, and generate threshold voltages VthH and VthL; and switching elements SW1 and SW2 which transmit the voltage VthH or VthL generated by the resistors R1, R2, and R3 to an inverting input terminal of the comparator 21. The threshold-voltage generating circuit 22 controls the switching elements S1 and SW2 to be complementarily turned on and off using a signal S2 output from the comparator and a signal generated by inverting the output signal S2 using an inverter INV. The threshold-voltage generating circuit 22 thereby selects one of the threshold voltages VthH and VthL and transmits the selected threshold voltage VthH or VthL to the inverting input terminal of the comparator 21. The threshold voltage transmitted to the inverting input terminal of the comparator 21 is denoted by Vth′.

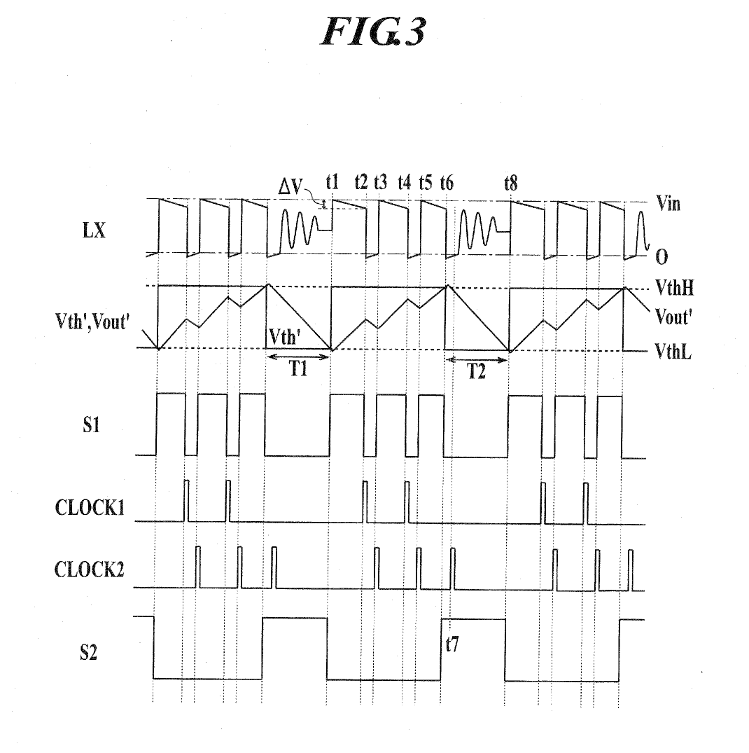

The operation of the DC-DC converter including the threshold-voltage generating circuit 22 configured as stated above according to the embodiment will next be described with reference to the timing chart in FIG. 3.

First, a state is explained in which the threshold voltage VthL is selected as the threshold voltage Vth′ transmitted to the inverting input terminal of the comparator 21, the switching element M1 is turned off and the switching element M2 is turned on, and the output voltage Vout decreases (period T1 in FIG. 3). In this case, the voltage Vout′, into which the output voltage Vout is divided by the bleeder resistors R11 and R12, gradually drops as the output voltage Vout drops.

At timing (timing t1 in FIG. 3) at which the voltage Vout′ becomes lower than the threshold voltage VthL, the signal S2 output from the comparator 21 changes from a high level to a low level. Then, the logic circuit 24 changes the signal S1 to a high level, thus changing the switching element M1 from OFF to ON state and the switching element M2 from ON to OFF state. As a result, the potential LX at the coil upstream terminal temporarily rises to an approximate input voltage Vin. At this time, the signal S2 output from the comparator 21 turns off the switching element SW2 and complementarily turns on the switching element SW1. The threshold voltage Vth′ to be transmitted to the inverting input terminal of the comparator 21 is thereby switched from VthL to VthH.

Thereafter, the potential LX at the coil upstream terminal gradually drops. When the potential reaches a certain potential, the LX-potential detecting circuit outputs a one-shot pulse CLOCK1 (timing t2). Then, the logic circuit 24 changes the signal S1 to the low level, thus changing the switching element M1 from the ON state to the OFF state and the switching element. M2 from the OFF state to the ON state.

As a result, the potential LX at the coil upstream terminal temporarily drops to be lower than the ground potential (0 V), which is the reference potential for the DC-DC converter. Thereafter, the potential LX at the coil upstream terminal gradually rises When the potential reaches 0 V (coil current IL=0), the LX-potential detecting circuit 23 outputs a one-shot pulse CLOCK2 (timing t3). Then, the logic circuit 24 changes the signal S1 to the high level, thus changing the switching element M1 from the OFF state to the ON state and the switching element M2 from the ON state to the OFF state. The potential LX at the coil upstream terminal thereby temporarily rises to an approximate input voltage Vin.

Thereafter, the potential LX at the coil upstream terminal gradually drops. When the potential reaches a certain potential, the LX-potential detecting circuit 23 outputs the one-shot pulse CLOCK1 (timing t4). Then, the logic circuit 24 changes the signal S1 to the low level, thus changing the switching element M1 from the ON state to the OFF state and the switching element M2 from the OFF state to the ON state. As a result, the potential LX at the coil upstream terminal temporarily drops to a potential lower than the ground potential (0 V). Subsequently, the potential LX at the coil upstream terminal gradually rises. When the potential reaches the ground potential (0 V), the LX-potential detecting circuit 23 outputs the one-shot pulse CLOCK2 (timing t5).

While the DC-DC converter is repeating such an operation cycle, the output voltage Vout and the divided voltage Vout′ gradually rise. When the output voltage Vout and divided voltage Vout′ reach the threshold voltage Vth′ (=VthH), the comparator 21 changes the output signal S2 from the low level to the high level (timing t6). As a result, the logic circuit 24 changes the signal S1 to the low level, thus changing the switching element M1 from the ON state to the OFF state and the switching element M2 from the OFF state to the ON state.

As a result, the potential LX at the coil upstream terminal falls to an approximate ground potential. Furthermore, the signal S2 output from the comparator 21 turns off the switching element. SW1 and complementarily turns on the switching element SW2, thus switching the threshold voltage Vth′ to be transmitted to the inverting input terminal of the comparator 21 from VthH to VthL.

Thereafter, when the LX-potential detecting circuit 23 outputs the one-shot pulse CLOCK2 (timing t7), the gate control signal GP2 to be output from the driver circuit 25 changes to the low level which turns off the switching element M2 adjacent the ground point. At this time, the gate control signal GP1 remains at the high level so that the switching element M1 keeps the off state.

As a consequence, the output voltage Vout and the divided voltage Vout′ continue to drop and the potential LX at the coil upstream terminal is held at an approximate ground potential (period T2 in FIG. 3). At timing (t8) at which the divided voltage Vout′ becomes lower than the threshold voltage VthL again, the comparator 21 changes the output signal S2 from the high level to the low level, thus returning the state of the DC-DC converter to the state at which the explanation of the operation started. By repeating the operation cycle, the switching regulator DC-DC converter according to the embodiment outputs a substantially constant output voltage Vout within a predetermined, ripple range.

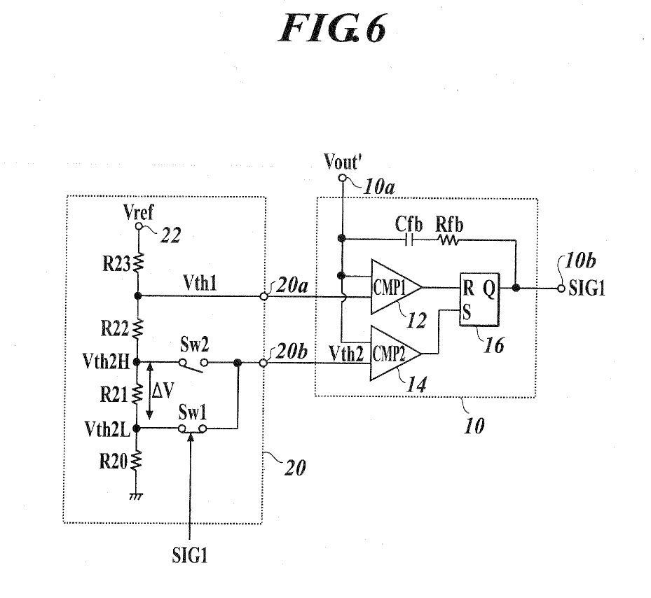

As described above, the DC-DC converter according to the embodiment can restrict the upper and lower limits of the output voltage Vout with one comparator 21. Unlike the conventional regulator illustrated in FIG. 6, the DC-DC converter according to the embodiment does not require two comparators. This configuration eliminates a problem in that the normal switching control is hampered when the threshold voltage Vth1 becomes lower than Vth2 (Vth1<Vth2) although the threshold voltages Vth1 and Vth2 are originally supposed to satisfy the relationship of Vth1>Vth2 because of the production tolerance in the components constituting the converter.

Note that, instead of outputting the one-shot pulses CLOCK1 and CLOCK2, the LX-potential detecting circuit 23 may output signals varying at the same timing to affect rise or decay.

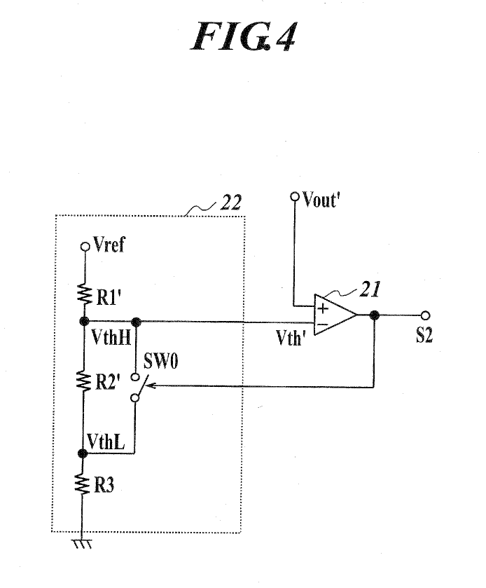

FIG. 4 illustrates another example of the circuit diagram of the threshold-voltage generating circuit 22 in the DC-DC converter according to the embodiment. The threshold-voltage generating circuit 22 illustrated in FIG. 4 includes a switching element SW0 provided in parallel to a dividing resistor R2′ out of dividing resistors R1′ to R3′ that generate the two threshold voltages VthH and VthL, and controls the switching element SW0 to be turned on or off based on the output from the comparator 21 (or its inverted signal through the inverter).

The threshold-voltage generating circuit 22 according to this example supplies the lower threshold voltage VthL to the inverting input terminal of the comparator 21 by turning on the switching element SW0 while the output from the comparator 21 is at high level, similarly to the threshold-voltage generating circuit 22 illustrated in FIG. 2. Moreover, the threshold-voltage generating circuit 22 can supply the high threshold voltage VthH to the inverting input terminal of the comparator 21 by turning off the element SW0 while the output from the comparator 21 is at low level. Note that the threshold-voltage generating circuit is not limited to the dividing circuit including the resistors as illustrated in FIGS. 2 and 4 but may be a circuit generating the threshold voltages VthL and VthH using, for example, Zener voltage of a Zener diode.

While the present invention made by the inventor has been specifically described so far based on the embodiment, the present invention is not limited thereto. For example, while the switching element M2 composed of the MOS transistor is employed as a rectifier connected between the coil upstream terminal and, the ground point, in this embodiment, a diode may he employed as the rectifier.

Moreover, in the embodiment, the switching elements M1 and M2 are described as the on-chip elements formed on the semiconductor chip on which the power supply control IC is also mounted. Alternatively, external elements formed separately from the power supply control IC may be employed as the switching elements M1 and M2. Furthermore, while the resistors formed on the chip are employed as the resistors R11 and R12 dividing the output voltage, the dividing resistors R1 and R2 may be external elements. In this case, divided voltage generated by the external dividing resistors is applied to a feedback terminal provided on the IC.

While the examples have been described in which the present invention is applied to the voltage-drop DC-DC converter, the present invention is not limited thereto but can be applied to a boost DC-DC converter or an inverting DC-DC converter generating negative voltage.

According to an aspect of the preferred embodiments of the present invention, there is provided a switching power-supply unit for outputting an output voltage different from an input voltage, including: an inductor connected between a voltage input terminal and an output terminal, wherein a direct-current voltage is input to the voltage input terminal, and a load is connected to the output terminal; a drive switching element which causes current to intermittently flow through the inductor; and a control circuit which generates and outputs a control signal which causes the drive switching element to be turned on or off in accordance with an output feedback voltage, wherein the control circuit includes: a terminal-potential detecting circuit which monitors potential at an upstream terminal of the inductor, and outputs a predetermined signal in accordance with a change in the potential at the upstream terminal; a comparator which compares the feedback voltage proportional to the output voltage with a predetermined threshold voltage; and a logic circuit which generates and outputs the control signal which controls the drive switching element based on a signal output from the comparator and the signal output from the terminal-potential detecting circuit, and wherein the comparator compares a first threshold voltage with the feedback voltage in a period in which the output voltage rises; compares a second threshold voltage with the feedback voltage in a period in which the output voltage drops, the second threshold voltage being lower than the first threshold voltage; and outputs a signal based on a result of the comparison.

According to this configuration, it is possible to achieve a voltage comparison circuit comparing the two threshold voltages Vth1 and Vth2, which restrict the upper and lower limits of the output voltage, with the output feedback voltage without a plurality of comparators. This can eliminate a problem in that the normal switching control cannot be exerted when the threshold voltage Vth1 becomes lower than Vth2 (Vth1<Vth2) although the threshold voltages Vth1 and Vth2 are originally supposed to satisfy the relationship of Vth1>Vth2 because of the production tolerance in the components constituting the comparator.

Preferably, the terminal-potential detecting circuit outputs a first signal when the potential at the upstream terminal drops to a predetermined potential after the drive switching element is turned on, and outputs a second signal when the potential at the upstream terminal rises to a predetermined potential after the drive switching element is turned off, and the logic circuit outputs the control signal which causes the drive switching element to be turned on or off in response to the first or second signal.

This can generate a control signal which causes the drive switching element to be turned on or off at appropriate timing so as to suppress the ripples of the output voltage while avoiding an increase in output current at a lower load.

Preferably, the logic circuit outputs the control signal which causes the drive switching element to be turned on when the signal output from the comparator varies from a first state to a second state or when the terminal-potential detecting circuit outputs the second signal, and which causes the drive switching element to be turned off when the signal output from the comparator varies from the second state to the first state or when the terminal-potential detecting circuit outputs the first signal.

This can achieve a switching power-supply unit capable of shortening continuous ON time of the drive switching element in the period in which the signal output from the comparator is in the first state, making the rise in the output voltage slower, and suppressing the ripples of the output voltage.

Preferably, the switching power-supply unit further includes a threshold-voltage generating circuit, the threshold-voltage generating circuit including: a voltage dividing circuit capable of generating the first threshold voltage and the second threshold voltage; and a switch which supplies one of the first threshold voltage and the second threshold voltage to the comparator, the first and second threshold voltages generated by the voltage dividing circuit in accordance with the signal output from the comparator.

This can achieve a relatively simple threshold-voltage generating circuit without the reversal of the magnitude relationship between the two threshold voltages.

According to the present invention, the switching power-supply unit including the comparator that restricts the upper and lower limits of the output voltage with the two threshold voltages can eliminate a problem in that the normal switching control cannot be exerted because of the production tolerance in the components constituting the comparator.

It should be understood that the embodiments disclosed above are not restrictive but illustrative only in all respects. The scope of the invention is intended to be shown not by the descriptions above but by the scope of the claims that follow. The scope of the invention, is intended to include the equivalents thereof and all the modifications within the scope of the invention.

The entire disclosure of Japanese Patent Application No. 2010-243746 filed on Oct. 29, 2010 including description, claims, drawings, and abstract are incorporated herein by reference in its entirety.

What is claimed is:

1. A switching power-supply unit for outputting an output voltage different from an input voltage, comprising:
an inductor connected between a voltage input terminal and an output terminal, wherein a direct-current voltage is input to the voltage input terminal, and a load is connected to the output terminal;
a drive switching element which causes current to intermittently flow through the inductor; and
a control circuit which generates and outputs a control signal which causes the drive switching element to be turned on or off in accordance with an output feedback voltage, wherein
the control circuit includes:
a terminal-potential detecting circuit which monitors potential at an upstream terminal of the inductor, and outputs a predetermined signal in accordance with a change in the potential at the upstream terminal;
a comparator which compares the feedback voltage proportional to the output voltage with a predetermined threshold voltage; and
a logic circuit which generates and outputs the control signal which controls the drive switching element based on a signal output from the comparator and the signal output from the terminal-potential detecting circuit, and wherein
the comparator compares a first threshold voltage with the feedback voltage in a period in which the output voltage rises; compares a second threshold voltage with the feedback voltage in a period in which the output voltage drops, the second threshold voltage being lower than the first threshold voltage; and outputs a signal based on a result of the comparison.

2. The switching power-supply unit according to claim 1, wherein
the terminal-potential detecting circuit outputs a first signal when the potential at the upstream terminal drops to a predetermined potential after the drive switching element is turned on, and outputs a second signal when the potential at the upstream terminal rises to a predetermined potential after the drive switching element is turned off, and
the logic circuit outputs the control signal which causes the drive switching element to be turned on or off in response to the first or second signal.

3. The switching power-supply unit according to claim 2, wherein
the logic circuit outputs the control signal which causes the drive switching element to be turned on when the signal output from the comparator varies from a first state to a second state or when the terminal-potential detecting circuit outputs the second signal, and which causes the drive switching element to be turned off when the signal output from the comparator varies from the second state to the first state or when the terminal-potential detecting circuit outputs the first signal.

4. The switching power-supply unit according to claim 1, further comprising a threshold-voltage generating circuit, the threshold-voltage generating circuit including:
a voltage dividing circuit capable of generating the first threshold voltage and the second threshold voltage; and
a switch which supplies one of the first threshold voltage and the second threshold voltage to the comparator, the first and second threshold voltages generated by the voltage dividing circuit in accordance with the signal output from the comparator.

5. The switching power-supply unit according to claim 2, further comprising a threshold-voltage generating circuit, the threshold-voltage generating circuit including:
a voltage dividing circuit capable of generating the first threshold voltage and the second threshold voltage; and
a switch which supplies one of the first threshold voltage and the second threshold voltage to the comparator, the first and second threshold voltages generated by the voltage dividing circuit in accordance with the signal output from the comparator.

6. The switching power-supply unit according to claim 3, further comprising a threshold-voltage generating circuit, the threshold-voltage generating circuit including:
a voltage dividing circuit capable of generating the first threshold voltage and the second threshold voltage; and a switch which supplies one of the first threshold voltage and the second threshold voltage to the comparator, the first and second threshold voltages generated by the voltage dividing circuit in accordance with the signal output from the comparator.
